(19) United States
(12) Patent Application Publication
(10) Pub. No.: US 2005/0117760 A1
(43) Pub. Date: Jun. 2, 2005

(54) Talking toilet paper holder

(76) Inventor: Charles Colby, Marina del Rey, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/673,624

(22) Filed: Sep. 29, 2003

Related U.S. Application Data
(63) Continuation-in-part of application No. 09/406,412, filed on Sep. 27, 1999, now Pat. No. 6,628,789.

(51) Int. Cl. H04B 1/00; G10L 11/00; B65D 85/66; B65H 16/02

(52) U.S. Cl. 381/124; 704/272; 242/570; 206/389; 446/270

(57) ABSTRACT

Talking toilet paper holder with a hollow toilet paper holding spindle having a compressible spring mounted shaft capable of inserting into a standard toilet paper roll holder. An electronic digital recording and playback mechanism housed within said paper holding spindle is activated by a record button flush with the surface of said hollow spindle. A power source such as a plurality of batteries is contained within said hollow spindle. A speaker is mounted flush within the spindle. A plurality of apertures within one end of the spindle enables a voice message to emit from said speaker through said end wall to the outer environment. The spindle is designed to be obscured from view when inside a toilet paper roll. A motion sensing switch and associated electronics causes a recorded or pre-recorded message to be played when the spindle is moved.

### CROSS-REFERENCE

This application is a continuation in part of application Ser. No. 09/406,412, which was filed on Ser. No. 09/27/1999 by inventor Charles Colby.

### BACKGROUND OF THE INVENTION

This invention relates generally to the field of toilet paper holders, and more particularly to a talking toilet paper holder.

Toilet paper is a common household item in the bathrooms of most homes in the U.S. To accommodate the convenient use and storage of toilet paper, most homes have toilet paper dispensing devices. Such devices usually consist of a pair of opposed arms each having a recess capable of holding a spring-loaded spindle.

Toilet paper commonly comes in roll form mounted on a hollow cardboard core. The user inserts the spindle into the core and inserts the spindle between the opposed arms of the roll holder that is commonly mounted on the bathroom wall in a convenient location.

Although the current toilet paper holding design of a spring loaded spindle and opposed arms to hold a roll of toilet paper is effective, the process of dispensing toilet paper can be made more informative, enjoyable and novel by having a pre-recorded message play when one begins the dispensing process. The message can be of a serious nature such as reminding a person to wash hands after use or reminding a person not to flush bulky items such as tampons or other unsuitable materials. The message can also be of a humorous nature, and indeed need not consist of words, but perhaps humorous sounds and the like.

### SUMMARY OF THE INVENTION

The primary object of the invention is to provide a novel toilet paper holder that emits a digital voice message when toilet paper is dispensed. Other objects and advantages of the present invention will become apparent from the following descriptions, taken in connection with the accompanying drawings, wherein, by way of illustration and example, an embodiment of the present invention is disclosed.

The principal embodiment of the present invention is: a Talking toilet paper holder comprising: A hollow toilet paper holding spindle having closed ends, one said end having a compressible spring mounting shaft capable of inserting into a standard toilet paper roll holder, the opposite said end having a fixed shaft member extending from said opposite ends' center capable of inserting into the opposing end of said standard toilet paper roll holder; an electronic digital recording and playback mechanism housed within said paper holding spindle; side springs to secure the spindle to said standard toilet paper roll holder; a record button and battery door flush with the surface of said hollow spindle, a power source such as a plurality of batteries contained within said hollow spindle, and a speaker mounted flush with the inside wall of said opposite flat end of said spindle. A plurality of apertures in said opposite end enables a voice message to emit from said speaker through said end wall to the outer environment. A motion sensing switch and associated electronics causes a recorded or pre-recorded message to play when said toilet paper holder is turned or otherwise moved.

Another embodiment of the present invention has a hole at an end of the spindle, to accommodate non-standard toilet paper roll holders that do not have dual end clips.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a front side view of the toilet paper holder of the present invention

FIG. 2 is a rear side section view of the toilet paper holder of the present invention.

FIG. 3 is an end view of the two ends of the toilet paper holder of the present invention.

FIG. 4 is a schematic diagram of the electronic portion of the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

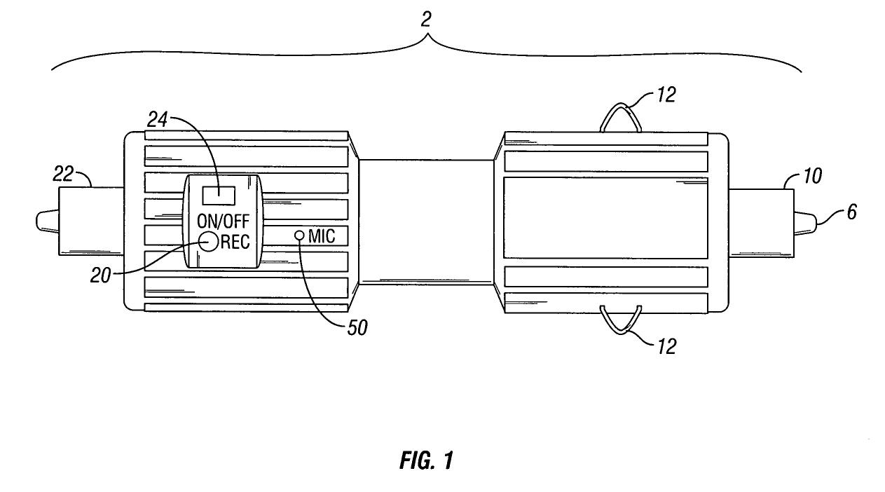

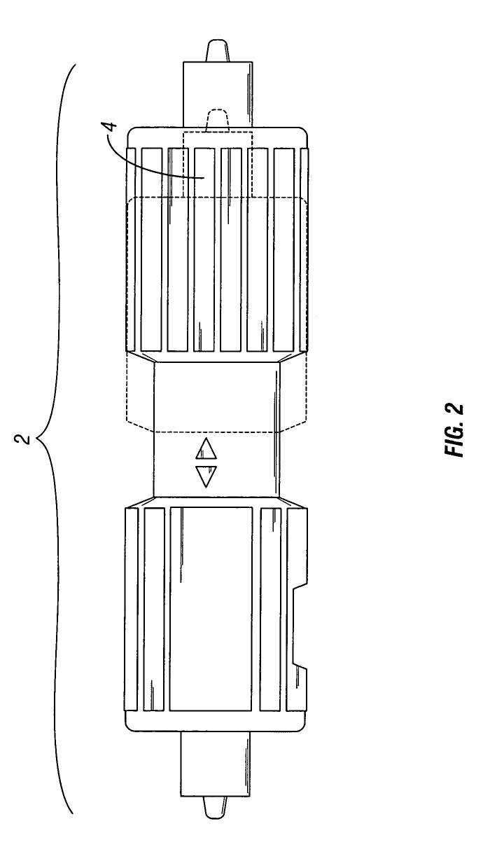

Referring now to FIG. 1 we see a side view of the toilet paper holder of the present invention. Spindle 2 is hollow and made of rigid molded plastic such as ABS. One end of spindle 2 is recessed 10 and has a compression spring terminating in a small shaft 6 emanating from its center. The opposite end of spindle 2 has a fixed shaft 22. The spindle 2 is essentially cylindrical and has a flush mounted record button 20, power switch 24, microphone opening 50 and battery door 4 (seen on FIG. 2) arranged on the surface of the cylinder. A plurality of spring clips 12 extend from the surface of the cylinder 2 such that when a toilet paper roll is slid onto the cylinder 2 the clips emanate from the surface of the toilet paper roll so that when the roll turns, the spindle 2 turns along with it. To make a voice recording the user presses record button 20 and speaks his or her message into microphone 50. An optional LED lights up while the recording is in progress turns off at the end of the recording process. A typical time for a digital recording is six to ten seconds.

A tilt switch is activated when the user pulls on the toilet paper roll causing spindle 2 to rotate: Said switch can be a mercury switch or the like so that when tilted it completes a circuit. The completion of the circuit causes a pre-recorded message to play once and then stop.

The spindle is designed to fit snugly within a roll of toilet paper of standard 1.5 inches in diameter, and be obscured from outside view.

FIG. 2 shows a side section of the present invention, wherein the battery doors 4 are shown to advantage.

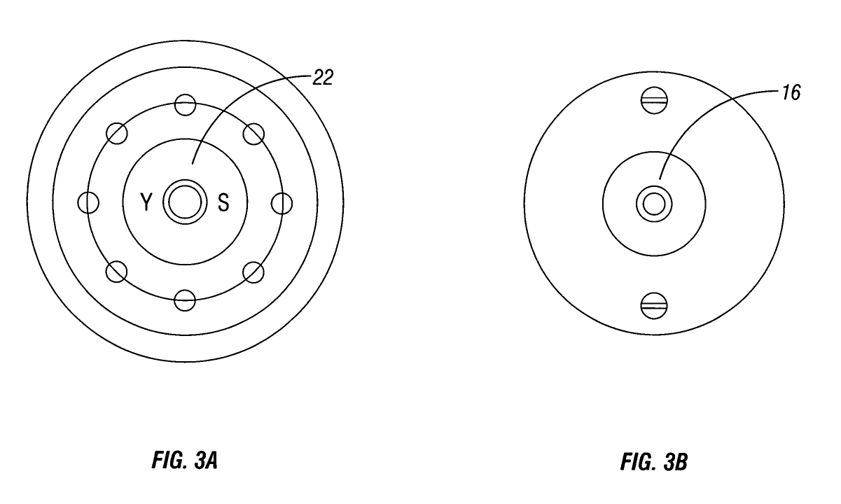

FIG. 3 shows end views of two embodiments of the present invention. FIG. 3A is the fixed end of the embodiment of FIGS. 1 and 2. FIG. 3B is the alternate embodiment showing the recessed hole for mounting the spindle in a nonstandard toilet paper holder.

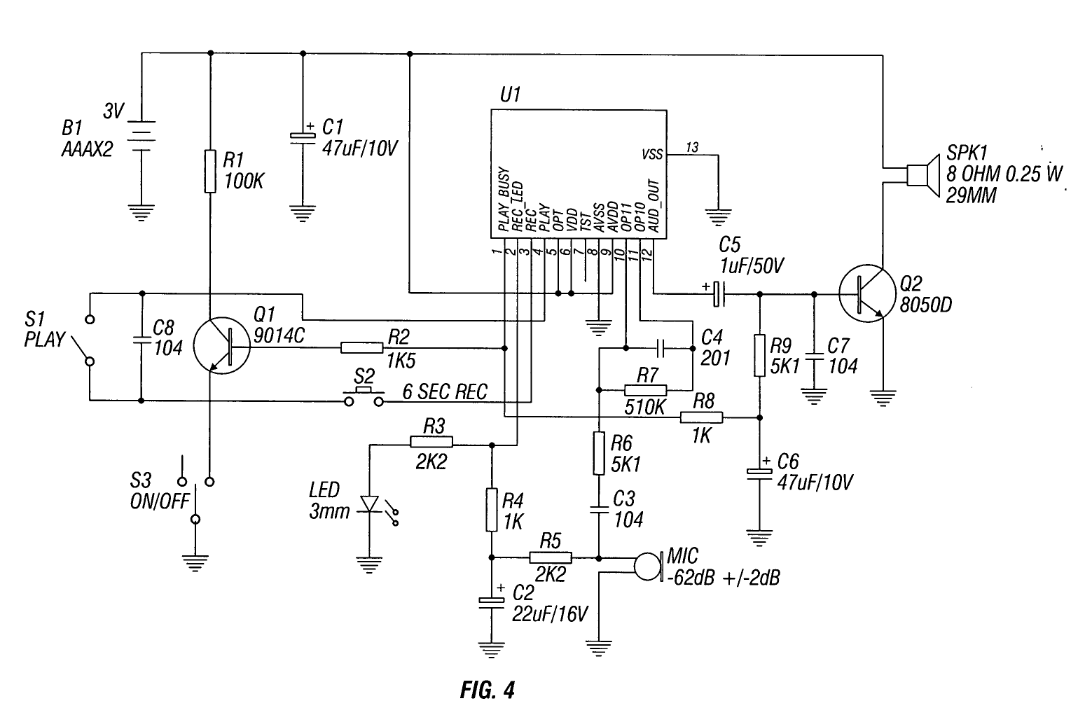

FIG. 4 is a schematic diagram of the electrical circuit of the present invention. At the heart of the electronics is a improved computer chip that allows the user to record voice recordings of optimally 45 to 60 seconds in total length, and accommodating 6-10 messages of average 8-second length. The chip can be exchanged at the factory for a pre-recorded chip of voice, music, other sounds, or any combination.

In the above described and illustrated way, a user can easily record a message into the toilet paper roll holder so that when a person pulls a paper from the roll the message will play.

While the invention has been described in connection with a preferred embodiment, it is not intended to limit the scope of the invention to the particular form set forth. On the contrary, it is intended to cover such alternatives, modifications, and equivalents as may be included within the spirit and scope of the invention as defined by the appended claims.

1. A talking toilet paper holder comprising:
A hollow toilet paper holding spindle having closed ends, one said end having a compressible spring mounting shaft capable of inserting into a standard toilet paper roll holder, the opposite said end having a fixed shaft member extending from said opposite ends' center capable of inserting into the opposite end of said standard toilet paper roll holder;
a plurality of spring clips extending from the surface of said spindle, and acting to secure said spindle to the interior core of a roll of toilet paper;
an electronic digital recording and playback mechanism housed within said paper holding spindle;
a record button and battery door flush with the surface of said hollow spindle;
a power source such as a plurality of batteries contained within said hollow spindle;
a speaker mounted flush with the inside wall of said opposite flat end of said spindle, a plurality of apertures in said opposite end enabling a voice message to emit from said speaker through said end to the outer environment; and
a motion sensing switch and associated electronics that causes a recorded message to play when said toilet paper holder is turned or moved.

2. A talking toilet paper holder comprising:
A hollow toilet paper holding spindle having one closed end, said end having a fixed shaft, the end opposite said end having a recessed area within said opposite end's center capable of inserting into the single clip of a single-clip toilet paper roll holder;
a plurality of spring clips extending from the surface of said spindle, and acting to secure said spindle to the interior core of a roll of toilet paper;
an electronic digital recording and playback mechanism housed within said paper holding spindle;
a record button and battery door flush with the surface of said hollow spindle;
a power source such as a plurality of batteries contained within said hollow spindle;
a speaker mounted flush with the inside wall of said opposite flat end of said spindle, a plurality of apertures in said opposite end enabling a voice message to emit from said speaker through said end to the outer environment; and
a motion sensing switch and associated electronics that causes a recorded message to play when said toilet paper holder is turned or moved.

3. A talking toilet paper holder according to claim 1 wherein said electronic digital recording and playback mechanism is capable of recording and playback of voice messages from an owner or operator of said holder.

4. A talking toilet paper holder according to claim 1 wherein said electronic digital recording and playback mechanism is pre-recorded at the factory wherein said device is manufactured.

5. A talking toilet paper holder according to claim 2 wherein said electronic digital recording and playback mechanism is capable of recording and playback of voice messages from an owner or operator of said holder.

6. A talking toilet paper holder according to claim 2 wherein said electronic digital recording and playback mechanism is pre-recorded at the factory wherein said device is manufactured.
